(19) United States
(12) Patent Application Publication
(10) Pub. No.: US 2002/0165818 A1
(43) Pub. Date: Nov. 7, 2002

(54) Infringement reporting clearinghouse

(76) Inventor: William K. Meade, II, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/847,074

(22) Filed: May 1, 2001

(51) Int. Cl. G06F 17/60

(52) U.S. Cl. 705/39

(57) ABSTRACT

An implementation of a technology, described herein, for facilitating the discovery of the existence of infringements, reporting discoveries of such infringements, and the resolution of such infringements. This technology acts as a clearinghouse for the reporting of patent infringements by the public and the presentation of such reports to interested parties, such as the patent holders. Infringement reporters are encouraged to report infringements because of the ease of reporting and incentives (e.g., monetary rewards) for doing so. In addition, the identity of the reporters is protected. This technology facilitates the resolution of infringements by negotiating, mediating, arbitrating, etc. a deal between anonymous infringers and interested parties. The technology manages payment of settlement/licensing fees so that the identity of the anonymous infringers remains protected. This technology may be used with other forms of infringement of intellectual property rights, such as copyright, trademark, and trade secret. Similarly, this technology may be used with other forms of violations. This abstract itself is not intended to limit the scope of this patent. The scope of the present invention is pointed out in the appending claims.

### TECHNICAL FIELD

This invention generally relates to a technology for facilitating the discovery of the existence of infringements, reporting discoveries of such infringements, and the resolution of such infringements.

### BACKGROUND

Generally, in the U.S., a person or business infringes a patent when it makes, uses, sells, or offers for sell something that is the subject of a valid, issued, unexpired patent. Patents generally cover apparatuses, systems, devices, processes, chemicals, genetics, plants, and ornamental designs. Those who are of ordinary skill in the art know what patents are and what an infringement of a patent is.

A patent-holder has the right to stop infringers of its patent from continuing to infringe the patent and to receive compensation for such infringement. The patent-holder's ultimate tool in enforcing its rights is litigation. The patent-holder may sue the infringer to stop their actions and recover damages for their actions.

Note that, as used herein, “infringement” and like terms include actual infringement, alleged infringement, and suspected infringement.

Recognition of patent rights and the threat of litigation encourages businesses to seek a license from the patent-holder. The patent-holder may receive monetary compensation in a licensing deal or a cross-license for valuable technology owned by the other party. In either case, licensing can be a lucrative and important resource.

However, a key problem is discovering patent infringements. In order to determine the existence of an infringement, one must be aware of a patent (and its claim coverage) and aware of product, system, action, etc. of a business (or person) that infringes the patent. Consequently, a business needs an elite corps of patent savvy people who are extraordinarily familiar with their own business' patent portfolio and are aware of (or have contact with) the actions and products of their competitors. Companies with strong licensing programs typically have 4-30 people dedicated to the task of policing their portfolio.

While this system is effective in finding some egregious infringements (e.g., top-selling products of competitors), it is highly unlikely that the “patent police” are likely to locate and identify the large numbers of infringements that are likely occurring, particularly in a large technology economy. These hidden infringements are just too small to be noticed or are occurring away from the public eye.

There is no legal obligation for a person or business to report a known infringement. Moreover, there is no incentive for a person or business to report a known infringement. There is no conventional system to reward an infringement discovery. Companies have no moral obligation to pay someone a “finder's fee.” Of course, an infringement discoverer may negotiate such a fee, but this process is fraught with problems. These include:

It is difficult to determine adequate and fair compensation.

The discoverer has a general lack of negotiation power because she is negotiating for the exchange of information; the company cannot assess the value of the information until it knows it.

Generally, only big infringements will be the ones reported in this fashion because the complications involved in reporting the infringements; but ironically, these are the types of infringements that a company's patent police are likely to find on their own.

This process is not anonymous and the identity of the infringement reporter is not protected; although the company may take steps to protect the identity of the reporter, it may be compelled during litigation to reveal who the reporter is; this fact greatly discourages reporting of infringements from within the corporate walls of the infringer.

Furthermore, since this process is not anonymous a small company is unlikely to report its own infringement of a patent owned by a mega-company because it fears that licensing demands will be unreasonable and that it cannot afford to fight a battle of attrition in the courts. Consequently, this small company keeps its mouth shut.

The result of this conventional approach is that a patent holder is blissfully uninformed of existing infringements. The lack of revenue from agreements with, settlements with, and judgments from these small infringers can amount to a large sum of money. Likewise, the lack of development from lost cross-licenses with such small infringers can amount to loss of strategic positioning, market slippage, and lost revenue.

### SUMMARY

Described herein is a technology for facilitating the discovery of the existence of infringements, reporting discoveries of such infringements, and the resolution of such infringements.

This technology acts as a clearinghouse for the reporting of patent infringements by the public and the presentation of such reports to interested parties, such as the patent holders. Infringement reporters are encouraged to report infringements because of the ease of reporting and incentives (e.g., monetary rewards) for doing so. In addition, the identity of the reporters is protected.

Moreover, this technology facilitates the resolution of infringements by negotiating, mediating, arbitrating, etc. a deal between anonymous infringers and interested parties. The technology manages payment of settlement/licensing fees so that the identity of the anonymous infringers remains protected.

This technology may be used with other forms of infringement of intellectual property rights, such as copyright, trademark, and trade secret. Similarly, this technology may be used with other forms of violations.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a schematic block diagram showing a patent-infringement-clearinghouse architecture in accordance with an implementation of the invention claimed herein.

FIG. 2 is a flow diagram showing a methodological implementation of the invention claimed herein.

FIG. 3 is a flow diagram showing a methodological implementation of the invention claimed herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of present invention, thereby better explain the present invention. Furthermore, for ease of understanding, certain method steps are delineated as separate steps; however, these separately delineated steps should not be construed as necessarily order dependent in their performance.

The following description sets forth one or more exemplary implementations of a patent infringement clearinghouse that incorporate elements recited in the appended claims. These implementations are described with specificity in order to meet statutory written description, enablement, and best-mode requirements. However, the description itself is not intended to limit the scope of this patent.

The inventor intends these exemplary implementations to be examples. The inventor does not intend these exemplary implementations to limit the scope of the claimed present invention. Rather, the inventor has contemplated that the claimed present invention might also be embodied and implemented in other ways, in conjunction with other present or future technologies.

An example of an embodiment of patent infringement clearinghouse may be referred to as an “exemplary infringement clearinghouse.”

Terminology

Unless indicated otherwise in the context, the term “infringement” and like terms, used herein, include actual infringement, alleged infringement, potential infringement, suspected infringement, etc. Herein, infringement refers to infringement of any intellectual property rights, which include, for example, the rights related to patents, copyrights, trademarks, trade secrets, unfair competition, and the like.

Herein, the term “violation” is a generic term referring to an infraction that violates laws, statutes, rules, regulations, etc. These may be state, federal, foreign, or international infractions. An infringement is a type of violation. Other types include infractions against customs laws, security laws, environmental laws, civil rights, civil laws, and criminal laws. Violations include any and all other types of infractions where legal recourse may be taken to right a wrong; compensate and/or punish for past, present, and future action; perform equity; and the like.

Introduction

The one or more exemplary implementations, described herein, of the present claimed invention may be implemented (in whole or in part) by an infringement clearinghouse architecture 100 and/or by a computing environment.

In general, the exemplary infringement clearinghouse encourages a strong patent economy by providing a mechanism to report patent infringements to the public at-large and an incentive to do so. Conventionally, no one—other than the patent holder—has an incentive to report known or suspected infringements or to look for such infringements.

Moreover, a business that knows or suspects that it is engaged in infringing activity may wish to “do the right thing” by reporting itself to the patent holder. However, it is unlikely to do that for fear of an unreasonable and unfair posturing by the patent holder. Instead, most businesses hope to “fly under the radar.”

The exemplary infringement clearinghouse adds additional radar stations by encouraging people and businesses other than the patent holder to report infringements. In addition, it removes some of the fear factor from a business reporting infringing activities performed by itself.

The exemplary infringement clearinghouse earns a profit by charging patent holders (or other interested parties) for reports of infringements. In addition, it charges a fee (which may be commission or a percentage) for negotiating an infringement resolution and for handling anonymous payment from infringer.

Although the implementations of the invention are described, herein, in terms of patent infringement, it may be used with other forms of infringement of intellectual property rights, such as copyright, trademark, and trade secret. Furthermore, one or more of the implementations of the invention may be used for other forms of violations and infractions.

Infringement Clearinghouse Architecture

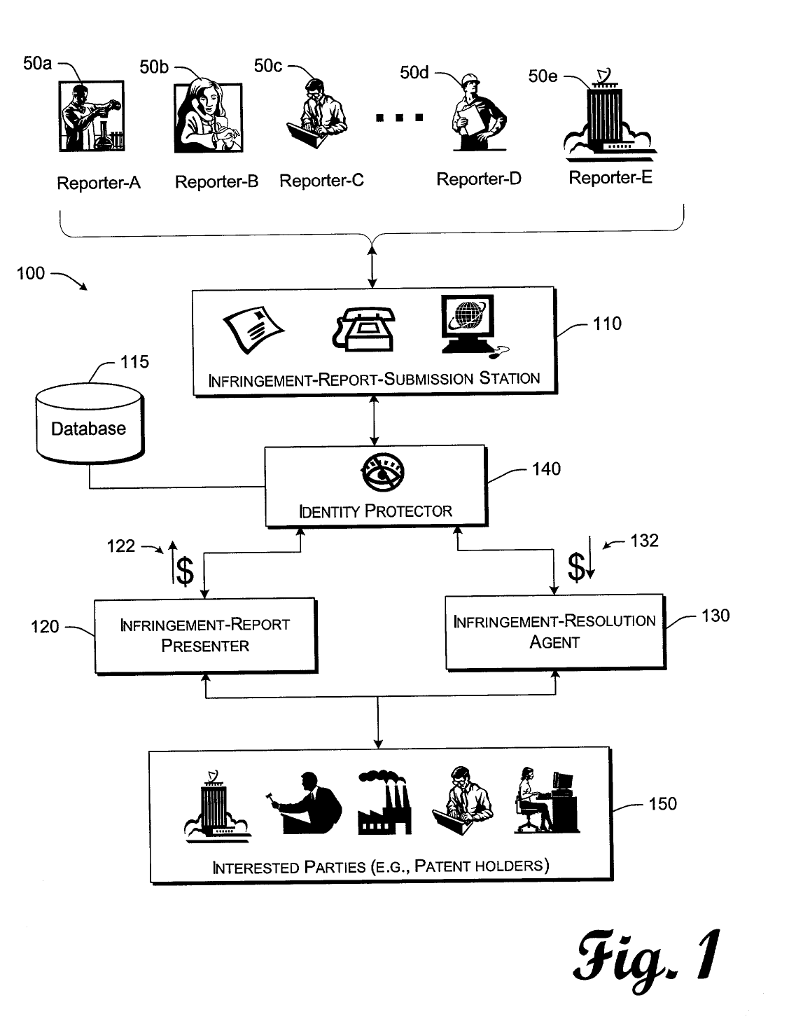

The exemplary infringement clearinghouse may be implemented by the infringement clearinghouse architecture 100 shown in FIG. 1 and described herein or other computing environments. Generally speaking, the infringement clearinghouse architecture 100 includes the following:

An infringement-report-submission station 110 for the public to report infringements of patents; includes a reporter-identity-protection scheme (implemented by an identify-protector 140).

An infringement-report presenter 120 for presenting infringement reports to interested parties (especially, those willing to pay for such information):

Uncategorized groups of infringement reports presented;

Categorized (e.g., by company, technology, subjective strength of patents, etc.) groups of infringement reports presented;

An infringement-resolution agent 130 for acting as a third party to facilitate a resolution to a reported infringement; to that end, the agent provides an anonymous payment system so that the infringer can pay the interested party, while protecting their identity.

The implementations of the infringement clearinghouse architecture 100 may employ the station, presenter, and agent and it may include multiple versions of each, where each version is associated with a particular type of industry (or other categories). Alternatively, implementations may employ some combination of the station, presenter, and agent or perhaps just one of each. Other alternative implementations may employ only a portion of one of the station, presenter, and agent.

FIG. 1 shows that the infringement clearinghouse architecture 100 includes the station 110, the presenter 120, the agent 130, and the identity protector 140.

The directional arrows of FIG. 1 are intended to give an overall impression of the general data flow through the systems. However, the flow has flexibility within it. It is not fixed.

Infringement-Report-Submission Station

As shown in FIG. 1, the infringement-report-submission station 110 is a communications center for the infringement clearinghouse architecture 100 with the infringement reporters.

FIG. 1 shows pictorial examples of infringement reporters. Specifically, it shows a chemical engineer (Reporter-A 50a); a business manager (Reporter-B 50b), a traveling office worker (Reporter-C 50c), a general contractor (Reporter-D 50d), and corporate headquarters for a company (Reporter-E 50e). A reporter can be nearly any person, business, or other entity. It may be an entity reporting another's infringing activity or its own.

A reporter submits an infringement report to the infringement-report-submission station 110 via nearly any communications mechanism. For example, the report may be submitted via traditional mail, other shipping couriers, e-mail, telephone (e.g., toll-free calls), Web page, etc. In this increasingly Internet-ubiquitous world, submission via Web page is an attractive option.

The infringement-report-submission station 110 is the mechanism for initiating contact with reporters and receiving additional contact from the inventors. The station 110 may send monetary awards to the reporters for their reports. Conversely, the station 110 may receive payments (e.g., settlement, licensing, judgments, etc.) from an infringer (which may be a reporter) to be paid to a patent holder anonymously.

The infringement-report-submission station 110 includes a database of information including information about reporters, reports, and such. This database may be part of or associated with database 115.

Why Would a Reporter Report Infringing Activity?

Under the conventional systems, the answer is that there is no reason to report infringing activity. Conventionally, it was too hard. It was risky (e.g., the reporter might feel the wrath of the exposed infringer). Other than a hardy handshake and a corporate “thank you,” there was no true reward for reporting.

However, with the exemplary infringement clearinghouse, it is easy to report via the station 110. There is little to no risk because the identity of the reporter is protected (via the identity protector 140, see below).

In addition, the reporter receives a monetary award for the report. This award may be a fixed fee. It may be a portion of the fee paid by the interested party for the infringement report. It may be a portion of the settlement/license/judgment. It may be any other reasonable compensation.

Other reasons that a reporter might report include:

reporting the actions of a competitor without the competitor discovering who reported it.

reporting the actions of an employer to force the employer to act in a legal and ethical manner, without the employer discovering who reported it (i.e., a “whistleblower”).

self-reporting own actions in hopes of getting a reasonable and fair license/settlement; thus a reporter may be an infringer.

Identity Protector

As shown in FIG. 1, the infringement clearinghouse architecture 100 includes the identity protector 140. It is an identity filter between the station 110 and the remainder of the architecture. It protects the identity of the reporters. The infringement-report presenter 120 presents infringement reports to interested parties 150 without identifying the reporter. Similarly, the infringement-resolution agent 130 negotiates settlements and licenses with interested parties 150 without identifying the reporter or infringer. The agent 130 may also handle settlement/license payments from the infringer in an anonymous fashion.

Coupled to the identity protector 140 is a database 115. This database includes the information about and associated with reports and reporters. The information therein may be classified and categorized. This information is accessed by the rest of the architecture. Since it goes through the identity protector 150, identity of the reporters (and infringers) is protected from downstream elements (e.g., the presenter 120, the agent 130, and the interested parties 150) and from other reporters. The identities may be accessible to the station 110 since it manages communications with the reporters.

Infringement-Report-Presenter

As shown in FIG. 1, the infringement clearinghouse architecture 100 also includes the infringement-report presenter 120 for presenting infringement reports to interested parties 150. An interested party 150 is any party that might have an interest in the existence of an infringement in a specific patent.

Generally, an interested party includes anyone willing to pay for information about infringement of a patent, someone with an economic right in such patent, someone hoping to obtain an economic right in such patent, someone simply curious about such information, and the like. Examples of interested parties include the owner of the subject patent (i.e., patent holder); the inventors of the invention of the subject patent; a licensee of the subject patent; an assign of the subject patent; anyone having a business arrangement with such holder, inventors, licensee, assign, etc.; and competitors of the same. Other examples of interested parties include attorneys (and law firms), those involved in an industry or technology of the subject patent; research entities; governments; academia; etc. These examples are only provided as non-restrictive illustrations.

The infringement-report presenter 120 may sell individual patent infringement reports; uncategorized groups of infringement reports; and/or categorized groups of infringement reports. Patent infringement reports may be categorized by, for example, company, technology, subjective strength of patents, subjective strength of the infringement evidence, etc.).

As indicated at 122 of FIG. 1, the interested parties 150 typically pays for the infringement report presentation from the infringement clearinghouse architecture 100. This payment may be a fixed fee. It may be a portion of any settlement/license/judgment obtained because of such infringement. It may be some other payment scheme, including a combination.

Infringement-Resolution-Agent

As shown in FIG. 1, the infringement clearinghouse architecture 100 includes the infringement-resolution agent 130. The agent 130 acts as a neutral third party to facilitate a resolution to a reported infringement. Without revealing the identity of the infringer (e.g., 50e), the agent 130 may negotiate, mediate, arbitrate, etc. a deal between the interested party 150 and the infringer. A settlement may be reached to pay for past infringement. A license may be created to pay for future use of the patented invention.

As indicated at 132 of FIG. 1, the interested parties 150 may receive license/settlement fee from the infringer (which is one of the reporters) via the infringement clearinghouse architecture 100. In this manner, the identity of the infringer is protected. The agent provides an anonymous payment system so that the infringer can pay the interested party, while protecting her identity.

The architecture receives some payment for this service. This payment may be a fixed fee. It may be a portion of any settlement/license fee being paid. It may be some other payment scheme, including a combination.

Methodological Implementation of the Exemplary Infringement Clearinghouse

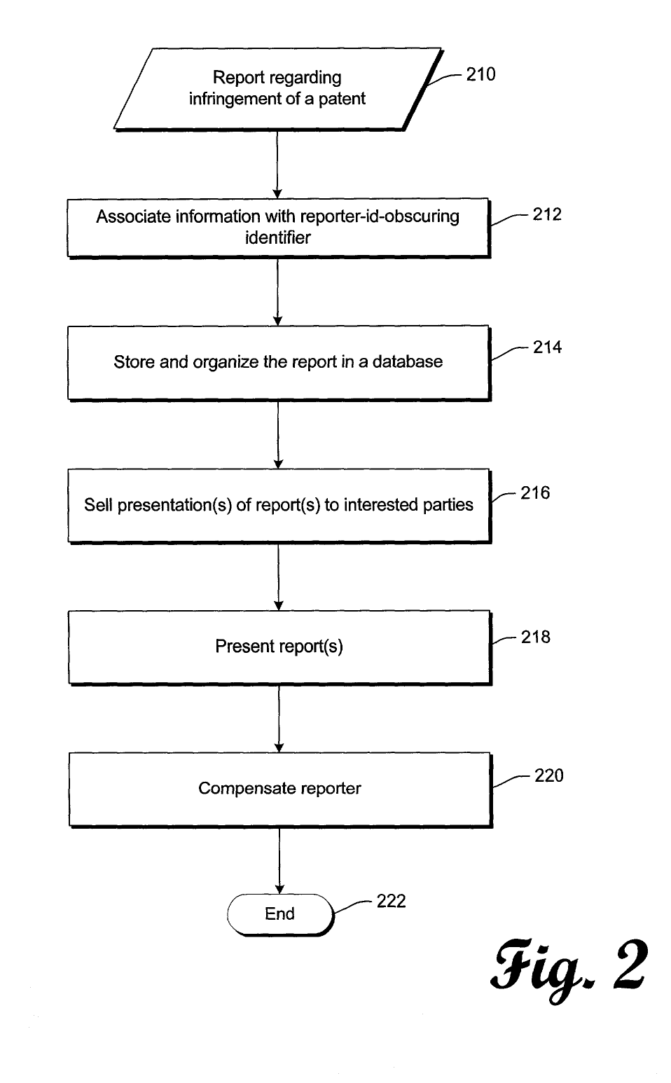

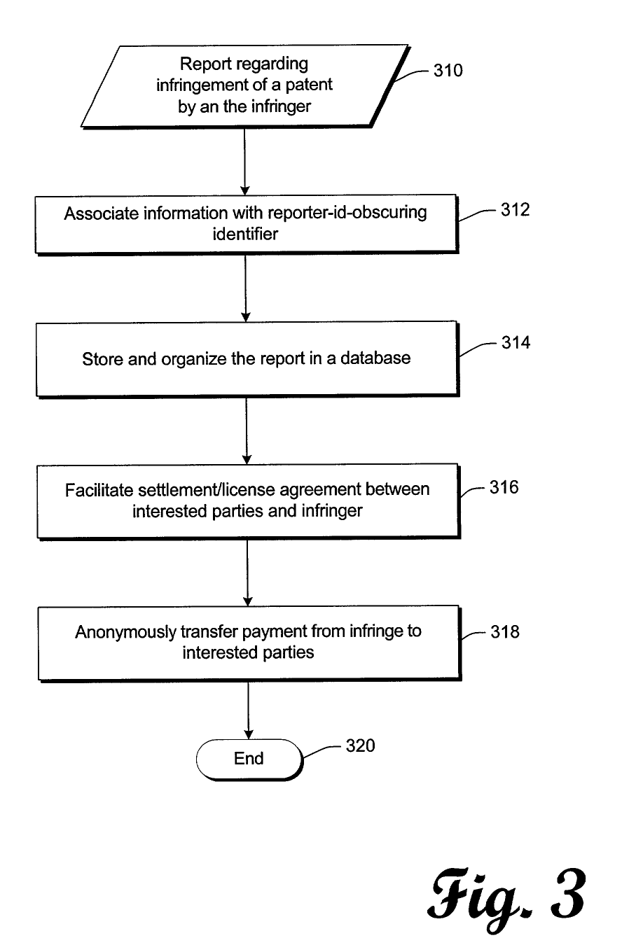

FIGS. 2 and 3 show methodological implementations of the exemplary infringement clearinghouse performed by the infringement clearinghouse architecture 100 (or some portion thereof). These methodological implementations may be performed in software, hardware, or a combination thereof.

FIG. 2 shows a report from a reporter at 210. The report is about a patent infringement. At 212, that report is associated with a reporter-id-obscuring identifier, which will allow the identity-protector to identify the reporter, but the presenter 120, agent 130, and interested parties 150 cannot identify the report.

At 214 of FIG. 2, the report is stored and organized in a database (such as database 115 in FIG. 1). At 216, the exemplary infringement clearinghouse sells one or more presentations of reports to interested parties. At 218, the sold reports are presented to the interested parties.

At 220, the reporter is compensated. The reporter is identified based upon their reporter-id-obscuring identifier. At 222, the process ends.

FIG. 3 show blocks 310-314, which are the same as corresponding blocks 210-214, except that that reporter of the infringement is the infringer.

At 316 of FIG. 2, the exemplary infringement clearinghouse negotiates, meditates, arbitrates, and/or otherwise facilitates a settlement/license agreement between interested parties and the infringer. If no agreement is reached, then the infringer remains unknown to the interested parties.

At 318, the exemplary infringement clearinghouse anonymously transfers the payments from the infringer to the interested parties. At 320, the process ends.

Exemplary Computing Environment

The section describes an example of a suitable computing environment within which the exemplary infringement clearinghouse may be implemented.

The exemplary infringement clearinghouse is described as a single entity, with memory and processing capabilities, for ease of discussion. In practice, however, it may be configured (in whole or in part) as one or more computing systems that jointly or independently perform the tasks of transforming the original digital good into the protected digital good.

Providing and describing the exemplary computing environment is not intended to suggest any limitation as to the scope of use or functionality of the exemplary infringement clearinghouse.

Generally, the computing environment includes a general-purpose (or special-purpose) computer. The components of computer may include, but are not limited to, one or more processors and a system memory. Typically, the computer is capable of using a variety of computer readable storage media. Such media may be any available media that is accessible by computer, and it includes both volatile and non-volatile media, so-called removable and so-called non-removable media.

For example, non-removable, volatile memory includes random access memory (RAM). Removeable, non-volatile memory includes read only memory (ROM) RAM typically contains data and/or program modules that are immediately accessible to and/or presently be operated on by the processor.

Examples of non-removable, non-volatile media include a so-called hard disk. Examples of removable, non-volatile media include a so-called floppy diskette and an optical disc (e.g., CD-ROM, DVD-ROM, and DVD-RAM). Hard drive may be a redundant array of disks.

These media provide storage of computer readable instructions, data structures, program modules, and other data for the computer. A number of program modules may be stored on the hard disk, magnetic disk, optical disk, ROM, or RAM, including, by way of example only, an operating system, one or more application programs, other program modules, and program data.

The computer may operate in a networked environment using logical connections to one or more remote computers, such as a remote computer. The remote computer may include many or all of the elements and features described herein relative to the computer.

The computer may be coupled to a local area network (LAN) or a general wide area network (WAN). Such networking environments are commonplace in offices, enterprise-wide computer networks, intranets, and the Internet.

Exemplary Infringement Clearinghouse is Not a Prior-Art Reporting Service

Bounty Quest™ (at www.bountyquest.com) is a prior-art reporting service. It offers monetary rewards (i.e., bounties) for information that is prior art to patented inventions. Such prior art may be used to invalidate patents (during, for example, litigation, pre-litigation, or negotiations) and/or prevent one from receiving a patent grant for an invention.

Unlike Bounty Quest™, the exemplary infringement clearinghouse does not seek reports of prior art. Instead, the exemplary infringement clearinghouse seeks reports of patent infringements. By its nature, prior art does not infringe a patent. It may invalidate it, but it does not infringe it.

The exemplary infringement clearinghouse seeks information about patent infringement, not prior art. The prior-art reporting service acts like efficiency experts invited into an old business to cut away the chaff. It gets rid of patents that should not have been granted. Conversely, the exemplary infringement clearinghouse acts like a new sales consultant who shows a business how to find new revenue from their existing markets and from new markets. It provides new avenues for licensing and enforcing patents.

Conclusion

Although the invention has been described in terms of patent infringement, it may be used with other forms of infringement of intellectual property rights, such as copyright, trademark, and trade secret. Similarly, this technology may be used with other forms of violations.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for facilitating reporting of patent infringements, the method comprising:
obtaining a report of patent infringement activity from a reporter, the reporter having an identity;
presenting information comprising the report to an interested party while protecting the identity of the reporter.

2. A method as recited in claim 1, wherein the interested party is a patent owner.

3. A method as recited in claim 1 further comprising receiving compensation for the presenting.

4. A method as recited in claim 1 further comprising providing compensation to the reporter for the report.

5. A method as recited in claim 1 further comprising persisting and organizing the report in a database containing similar reports.

6. A method as recited in claim 1, wherein the reporter is an infringer, the method further comprising facilitating a resolution of an infringement conflict between the interested party and the infringer.

7. A method as recited in claim 6, wherein, during the facilitating, the identity of the infringer is protected.

8. A method as recited in claim 6 further comprising facilitating transfer of fee resulting from the resolution from the infringer to the interested party.

9. A method as recited in claim 6 further comprising facilitating transfer of fee resulting from the resolution from the infringer to the interested party, while protecting the identity of the infringer.

10. A computer-readable medium having computer-executable instructions that, when executed by a computer, performs a method comprising:
obtaining a report of patent infringement activity from a reporter, the reporter having an identity;
presenting information comprising the report to an interested party while protecting the identity of the reporter.

11. A method for facilitating reporting of violations, the method comprising:
obtaining a report of a violation from a reporter, the reporter having an identity;
presenting information comprising the report to an interested party while protecting the identity of the reporter.

12. A method as recited in claim 11, wherein the identity of the reporter is protected during the presenting.

13. A method as recited in claim 11, wherein multiple reports are obtained by the obtaining and multiple reports are presented by the presenting.

14. A method as recited in claim 13 further comprising classifying the multiple reports.

15. A method as recited in claim 11, wherein the violation is an infringement of an intellectual property right.

16. A method as recited in claim 15, wherein the intellectual property right is related to a one or more rights selected from a group consisting patents, copyrights, trademarks, trade dress, trade dilution, trade secrets, and unfair competition.

17. A method as recited in claim 11, wherein the violation is a violation of one or more laws selected from a group consisting of environmental laws and customs laws.

18. A method as recited in claim 11, wherein the interested party is a patent owner.

19. A method as recited in claim 11 further comprising receiving compensation for the presenting.

20. A method as recited in claim 11 further comprising providing compensation to the reporter for the report.

21. A method as recited in claim 11 further comprising persisting and organizing the report in a database containing similar reports.

22. A method as recited in claim 11, wherein the reporter is a violator, the method further comprising facilitating a resolution of a violation conflict between the interested party and the violator.

23. A method as recited in claim 22, wherein, during the facilitating, the identity of the violator is protected.

24. A method as recited in claim 22 further comprising facilitating transfer of fee resulting from the resolution from the violator to the interested party.

25. A method as recited in claim 22 further comprising facilitating transfer of fee resulting from the resolution from the violator to the interested party, while protecting the identity of the violator.

26. A method as recited in claim 11, wherein the obtaining comprises receiving reports via the Internet.

27. A method as recited in claim 11, wherein the obtaining comprises generating Web pages for delivery over the Internet.

28. A computer-readable medium having computer-executable instructions that, when executed by a computer, performs a method comprising:
obtaining a report of a violation from a reporter, the reporter having an identity;
presenting information comprising the report to an interested party while protecting the identity of the reporter.

29. A method for facilitating reporting of patent infringements, the method comprising:
obtaining a report of patent infringement activity from an infringer, the infringer having an identity;
facilitating a resolution of an infringement conflict between an interested party and the infringer.

30. A computer-readable medium having computer-executable instructions that, when executed by a computer, performs a method comprising:
obtaining a report of patent infringement activity from an infringer, the infringer having an identity;
facilitating a resolution of an infringement conflict between an interested party and the infringer.

31. A method for facilitating reporting of violations, the method comprising:
obtaining a report from a violator of its violation, the violator having an identity;
facilitating a resolution of a violation conflict between an interested party and the violator.

32. A method as recited in claim 31, wherein the violation is an infringement of an intellectual property right.

33. An architecture for facilitating reporting of violations, the architecture comprising:
a violation-report-submission station configured to obtain a report of a violation from a reporter, the reporter having an identity;
a violation-report presenter configured to present information comprising the report to an interested party while protecting the identity of the reporter.

34. An architecture as recited in claim 33 further comprising a database configured to store the report.

35. An architecture as recited in claim 33, wherein the violation is an infringement of an intellectual property right.
